(19) United States
(12) Patent Application Publication
(10) Pub. No.: US 2025/0162395 A1
(43) Pub. Date: May 22, 2025

(54) ELECTRIC VEHICLE STRUCTURE

(71) Applicants: Hyundai Motor Company, Seoul (KR); Kia Corporation, Seoul (KR)

(72) Inventors: Won Hae LEE, Seoul (KR); Chang Kyu KIM, Hwaseong-Si (KR); Nam Ho KIM, Gwangmyeong-si (KR); Byung Joo CHUNG, Gunpo-Si (KR); Byong Cheol KIM, Seoul (KR); Seung Hak LEE, Asan-Si (KR); Mi Ran PARK, Hwaseong-Si (KR)

(73) Assignees: Hyundai Motor Company, Seoul (KR); Kia Corporation, Seoul (KR)

(21) Appl. No.: 18/651,143

(22) Filed: Apr. 30, 2024

(30) Foreign Application Priority Data
Nov. 22, 2023 (KR) 10-2023-0163488

(51) Int. Cl. B60K 1/04; B60K 11/00; B62D 21/03; H01M 10/613; H01M 10/625; H01M 50/24; H01M 50/242; H01M 50/249; H01M 50/271

(52) U.S. Cl. CPC B60K 1/04; B60K 11/00; B62D 21/03; H01M 10/613; H01M 10/625; H01M 50/24; H01M 50/242; H01M 50/249; H01M 50/271; B60K 2001/0438; H01M 2220/20

(57) ABSTRACT

An electric vehicle structure includes a chassis frame having a first closed curve that surrounds a battery accommodation space, a watertight panel having another closed curve that surrounds the inside of the closed curve that surrounds the battery accommodation space of the chassis frame, an upper cover coupled to an upper side of the watertight panel and covering an upper side of the battery accommodation space, and an under cover coupled to a lower side of the watertight panel and covering a lower side of the battery accommodation space.

### CROSS-REFERENCE TO RELATED APPLICATION

The present application claims priority to Korean Patent Application No. 10-2023-0163488, filed on Nov. 22, 2023, the entire contents of which is incorporated herein for all purposes by this reference.

### BACKGROUND OF THE PRESENT DISCLOSURE

### Field of the Present Disclosure

The present disclosure relate to a technology associated with an electric vehicle structure.

### Description of Related Art

An electric vehicle is provided with a motor configured to generate power for driving the vehicle. The electric vehicle is provided with a battery that stably supplies electric power to the motor.

The battery is typically mounted in a form of a battery pack in the vehicle, and the battery pack accommodates a plurality of battery modules in a pack case. The battery module has a shape in which a plurality of battery cells is stacked.

In general, the battery pack is separately mounted at a lower side of a vehicle body.

Meanwhile, because a travelable distance of the electric vehicle greatly depends on the number of battery modules mounted in the vehicle, the vehicle needs to be able to accommodate as many battery modules as possible.

Furthermore, the battery module mounted in the vehicle needs to be accommodated in a watertight space to prevent outside foreign substances, such as moisture, from penetrating thereinto.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an electric vehicle structure which may effectively increase a travelable distance of a vehicle by maximizing the number of battery modules to be mounted while reducing a weight of the vehicle and enabling efficient spatial utilization and use a comparatively simple configuration to reliably ensure watertightness of a space in which the battery module is accommodated.

To achieve the above-mentioned object, various aspects of the present disclosure are directed to providing an electric vehicle structure including: a chassis frame having a first closed curve that surrounds a battery accommodation space; a watertight panel having a second closed curve that surrounds an inside of the first closed curve that surrounds the battery accommodation space of the chassis frame; an upper cover coupled to an upper side of the watertight panel and covering an upper side of the battery accommodation space; and an under cover coupled to a lower side of the watertight panel and covering a lower side of the battery accommodation space.

The closed curve, which surrounds the battery accommodation space of the chassis frame, may be defined by center side members provided at first and second opposite sides of the chassis frame of a vehicle and elongated in a forward and rearward direction of the vehicle, front and rear cross members connecting the center side members at the first and second opposite sides, elongated in a transverse direction of the vehicle, and spaced from each other in the forward and rearward direction of the vehicle.

The watertight panel may be formed so that an inclined wall, which extends along internal surfaces of the center side members, an internal surface of the front cross member, and an internal surface of the rear cross member, defines the second closed curve.

The inclined wall of the watertight panel may be inclined downwardly from the upper side of the battery accommodation space toward the inside of the battery accommodation space.

A flange portion may be provided on at least one of upper and lower end portions of the inclined wall of the watertight panel and smoothly extend in a horizontal direction thereof.

At least one of the center side members, the front cross member, and the rear cross member may include an internal wall provided in a form of a vertical wall surface directed toward the watertight panel, and a mounting protruding portion may be provided on the internal wall, which is provided in a form of the vertical wall surface, and locally protrude to be in surface-contact with the inclined wall of the watertight panel.

A plurality of internal members may be provided in the watertight panel and traverse the inside of the battery accommodation space, and the mounting protruding portion may be formed to face an end portion of the internal member.

An upper sealing strip may be provided at an upper end portion of the watertight panel and compressed against the upper cover to improve watertightness.

An under sealing strip may be provided at a lower end portion of the watertight panel and compressed against the under cover to improve watertightness.

Furthermore, to achieve the above-mentioned object, various aspects of the present disclosure are directed to providing an electric vehicle structure including: side members defining first and second opposite sides of a chassis frame; a plurality of cross members connecting the side members at the first and second opposite sides; a watertight panel inserted into a closed curve defined by the side members and the cross members, the watertight panel being configured to define a closed curved surface having a predetermined width in an upward and downward direction and having watertightness; and an upper cover provided to surround an upper side of a battery accommodation space surrounded by the closed curved surface defined by the watertight panel.

The closed curve of the chassis frame may be defined by center side members, which are positioned between front side members and rear side members of the side members, a front cross member, which connects first and second opposite end portions of front sides of the center side members, and a rear cross member that connects first and second opposite end portions of rear sides of the center side members.

The closed curved surface, which has the predetermined width in the upward and downward direction of the watertight panel, may be defined by an inclined wall inclined downwardly from the upper side of the battery accommodation space toward the inside of the battery accommodation space.

A flange portion may be provided at an upper end portion of the inclined wall of the watertight panel and smoothly extend in a horizontal direction thereof.

An upper sealing strip may be provided at an upper end portion of the inclined wall of the watertight panel and compressed against the upper cover to improve watertightness.

The upper sealing strip may be provided to be compressed against an inside of a bent portion of the upper cover.

An under cover may be provided at a lower side of the watertight panel and surround a lower side of the battery accommodation space, and an under sealing strip may be provided at a lower end portion of the inclined wall of the watertight panel and compressed against the under cover to improve watertightness.

A cooling panel may be provided at a lower side of the inclined wall of the watertight panel and surround a lower side of the battery accommodation space, and an under cover may be provided at a lower side of the cooling panel and surround a lower side of the cooling panel.

A bottom portion may be integrated with the watertight panel and extend from a lower end portion of the inclined wall to seal a lower side of the battery accommodation space.

At least one of the center side members, the front cross member, and the rear cross member, which face the inclined wall of the watertight panel, may include a mounting protruding portion protruding to be locally in surface-contact with the inclined wall.

A plurality of internal members may be provided in the watertight panel and have end portions supported on the inclined wall of the watertight panel, and the mounting protruding portion may be formed at a position facing the end portion of the internal member.

According to an exemplary embodiment of the present disclosure, it is possible to effectively increase a travelable distance of a vehicle by maximizing the number of battery modules to be mounted while reducing a weight of the vehicle and enabling efficient spatial utilization and use a comparatively simple configuration to reliably ensure watertightness of a space in which the battery module is accommodated.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a view exemplarily illustrating an electric vehicle structure according to an exemplary embodiment of the present disclosure.

FIG. 2 is a top plan view of FIG. 1.

FIG. 3 is a bottom plan view of FIG. 1.

FIG. 4 is a view exemplarily illustrating a watertight panel in FIG. 1.

FIG. 5 is a locally detailed view of FIG. 1 that illustrates a state in which the watertight panel is excluded.

FIG. 6 is a view exemplarily illustrating a mounting protruding portion formed on a center side member.

FIG. 7 is a cross-sectional view taken along line VII-VII in FIG. 5.

FIG. 8 is a cross-sectional view taken along line VIII-VIII in FIG. 5.

FIG. 9 is a view for explaining a state in which an upper sealing strip and an under sealing strip are provided at an upper end portion and a lower end portion of the watertight panel.

FIG. 10 is a detailed view of the upper side of FIG. 9.

FIG. 11 is a view exemplarily illustrating another exemplary embodiment of the watertight panel.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments included in the present specification will be described in detail with reference to the accompanying drawings. The same or similar constituent elements are assigned with the same reference numerals regardless of reference numerals, and the repetitive description thereof will be omitted.

The suffixes “module”, “unit”, “part”, and “portion” used to describe constituent elements in the following description are used together or interchangeably to facilitate the description, but the suffixes themselves do not have distinguishable meanings or functions.

In the description of the exemplary embodiments included in the present specification, the specific descriptions of publicly known related technologies will be omitted when it is determined that the specific descriptions may obscure the subject matter of the exemplary embodiments included in the present specification. Furthermore, it should be interpreted that the accompanying drawings are provided only to allow those skilled in the art to easily understand the exemplary embodiments included in the present specification, and the technical spirit included in the present specification is not limited by the accompanying drawings, and includes all alterations, equivalents, and alternatives that are included in the spirit and the technical scope of the present disclosure.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “directly coupled to” or “directly connected to” another constituent element, it should be understood that no intervening constituent element is present between the constituent elements.

Singular expressions include plural expressions unless clearly described as different meanings in the context.

In the present specification, it should be understood the terms “comprises,” “comprising,” “includes,” “including,” “containing,” “has,” “having” or other variations thereof are inclusive and therefore specify the presence of stated features, integers, steps, operations, elements, components, or combinations thereof, but do not preclude the presence or addition of one or more other features, integers, steps, operations, elements, components, or combinations thereof.

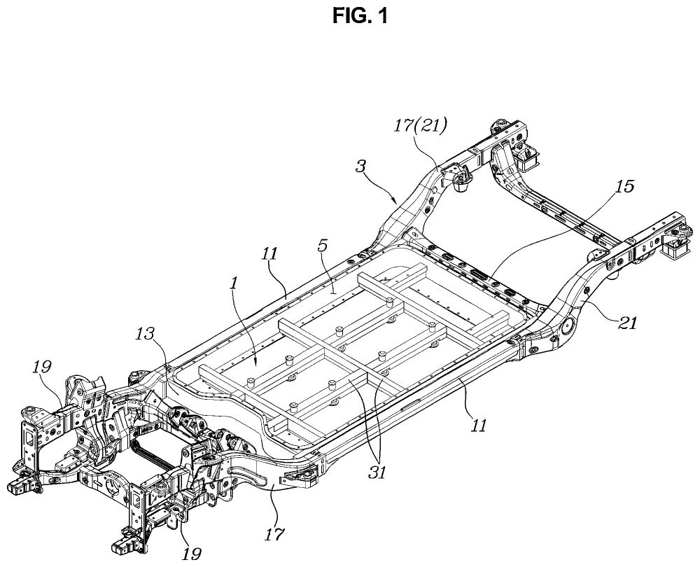

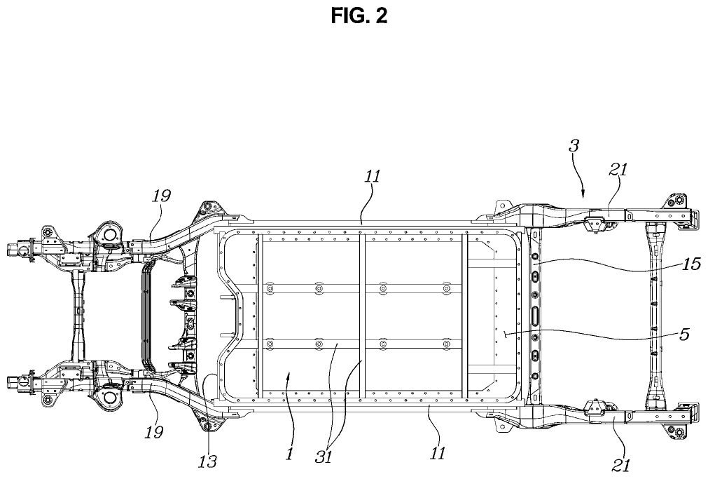

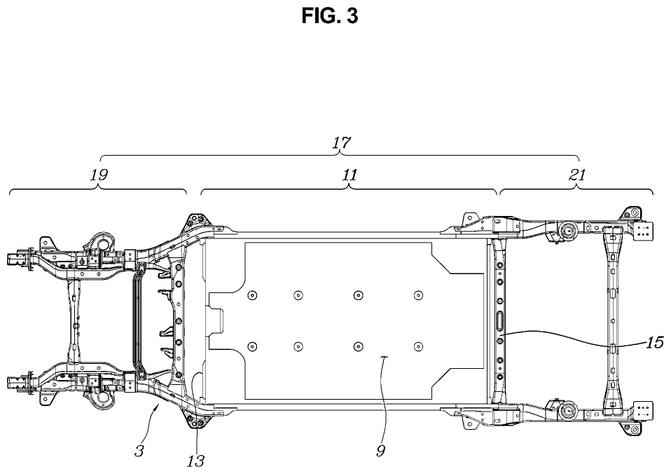

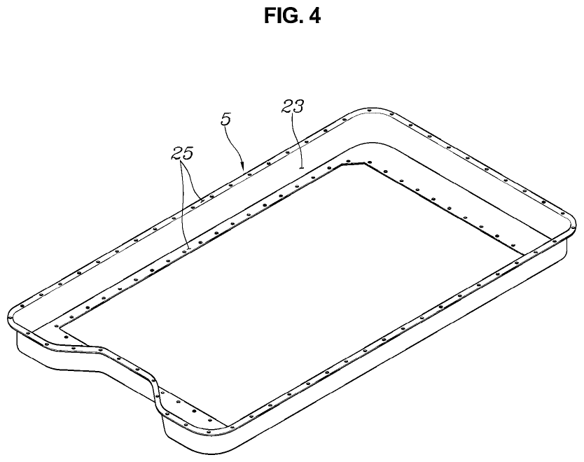

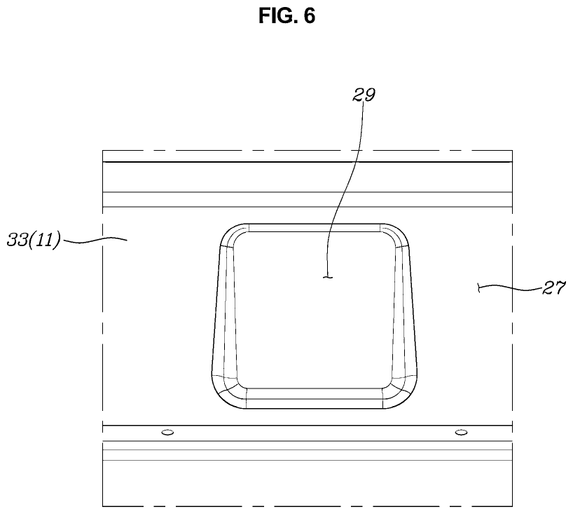

With reference to FIGS. 1 to 10, an exemplary embodiment of an electric vehicle structure of the present disclosure includes a chassis frame 3 configured to define a first closed curve that surrounds a battery accommodation space 1, a watertight panel 5 configured to define another closed curve that surrounds the inside of the closed curve that surrounds the battery accommodation space 1 of the chassis frame 3, an upper cover 7 coupled to an upper side of the watertight panel 5 and configured to cover an upper side of the battery accommodation space 1, and an under cover 9 coupled to a lower side of the watertight panel 5 and configured to cover a lower side of the battery accommodation space 1.

That is, in the electric vehicle structure of the present disclosure, the battery accommodation space is formed in the closed curve defined by the chassis frame 3. Therefore, in comparison with a configuration in the related art in which a separate battery pack is mounted on a vehicle body, it is possible to maximize the number of battery modules to be mounted while reducing a weight of the vehicle and enabling efficient spatial utilization, effectively increasing a travelable distance of the vehicle.

Furthermore, the battery accommodation space 1 may be effectively sealed by the watertight panel 5, the upper cover 7, and the under cover 9, reliably ensuring watertightness of the battery accommodation space 1 by use of a simple configuration.

In the instant case, the closed curve, which surrounds the battery accommodation space 1 of the chassis frame 3, may be defined by center side members 11 provided at two opposite sides of the chassis frame 3 of the vehicle and elongated in a forward and rearward direction of the vehicle, and front and rear cross members 13 and 15 configured to connect the center side members 11 at the two opposite sides, elongated in a transverse direction of the vehicle, and spaced from each other in the forward and rearward direction of the vehicle.

The chassis frame 3 is configured so that side members 17, which are elongated in the forward and rearward direction of the vehicle, are provided at the two opposite sides, and the plurality of cross members is provided to be elongated in the transverse direction of the vehicle body and connects the side members 17.

The side members 17 include front side members 19 configured to define a front side of the vehicle, and rear side members 21 configured to define a rear side of the vehicle. The front side members 19 and the rear side members 21 are connected to front and rear sides of the center side members 11 that connect the front side members 19 and the rear side members 21.

The front cross member 13 is provided to connect the front sides of the center side members 11, and the rear cross member 15 is provided to connect the rear sides of the center side members 11.

That is, in an exemplary embodiment of the present disclosure, the closed curve, which defines the battery accommodation space 1 surrounded by the chassis frame 3, is defined by the center side members 11, the front cross member 13, and the rear cross member 15. The battery accommodation space 1 may accommodate as many battery modules as possible but does not occupy upper and lower spaces of the chassis frame 3 at ordinary times, ultimately maximizing the spatial utilization of the vehicle and reducing the weight of the vehicle.

The watertight panel 5 is formed so that an inclined wall 23, which extends along internal surfaces of the center side members 11, an internal surface of the front cross member 13, and an internal surface of the rear cross member 15, defines the second closed curve.

The inclined wall 23 of the watertight panel 5 is formed to be inclined downwardly from the upper side of the battery accommodation space toward the inside of the battery accommodation space.

That is, the watertight panel 5 may be integrally formed by deep drawing so that the inclined wall 23 may be formed in a shape that defines the single closed curve.

The center side members 11, the front cross member 13, and the rear cross member 15 mainly are configured to provide structural rigidity of the vehicle. The center side members 11, the front cross member 13, and the rear cross member 15 are mainly configured by pressed products made of steel materials and coupled to one another by welding or the like. It is difficult to ensure the shape consistency and predetermined flatness of the coupling portions between the center side members 11, the front cross member 13, and the rear cross member 15. For the present reason, it is difficult to provide complete watertightness to the battery accommodation space when the center side members 11, the front cross member 13, and the rear cross member 15 are coupled together with the upper cover 7 and the under cover 9.

According to an exemplary embodiment of the present disclosure, in the above-mentioned situation, the continuous surface of the inclined wall 23 of the watertight panel 5 surrounds the inside of the closed curve defined by the center side members 11, the front cross member 13, and the rear cross member 15 as described above, which makes it possible to easily ensure the complete watertightness of the battery accommodation space 1.

The configuration using the watertight panel 5 may more securely maintain the watertightness of the battery accommodation space 1 even in a situation in which the chassis frame 3 twists.

Meanwhile, a flange portion 25 may be provided on at least one of upper and lower end portions of the inclined wall 23 of the watertight panel 5 and smoothly extend in a horizontal direction thereof.

The flange portion 25 may remarkably improve coupling characteristics between the upper cover 7 and the watertight panel 5 or between the under cover 9 and the watertight panel 5, more easily and completely ensuring the watertightness.

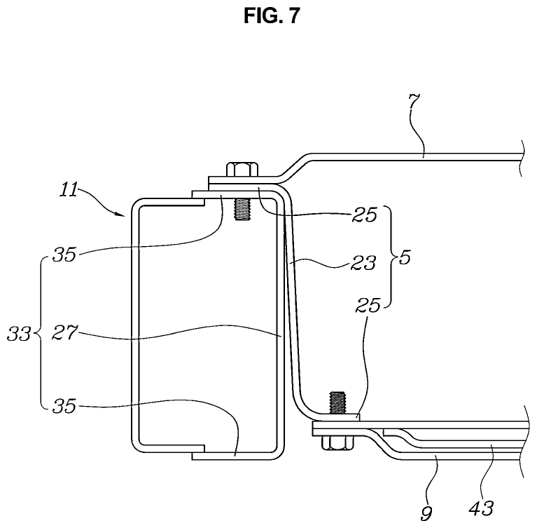

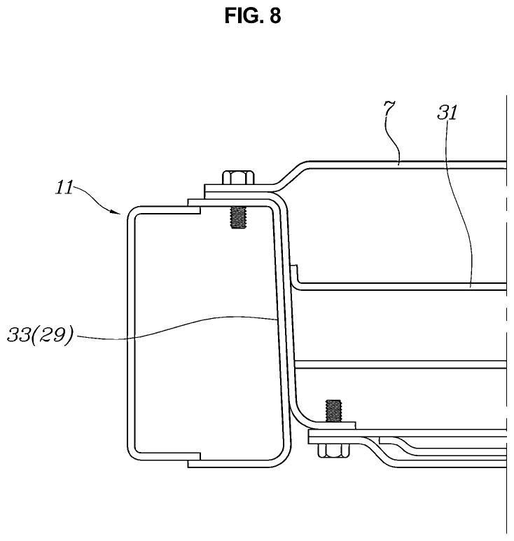

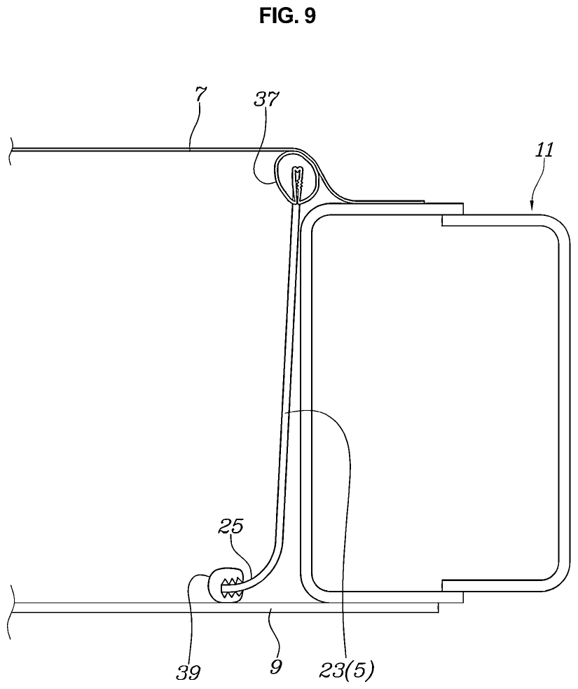

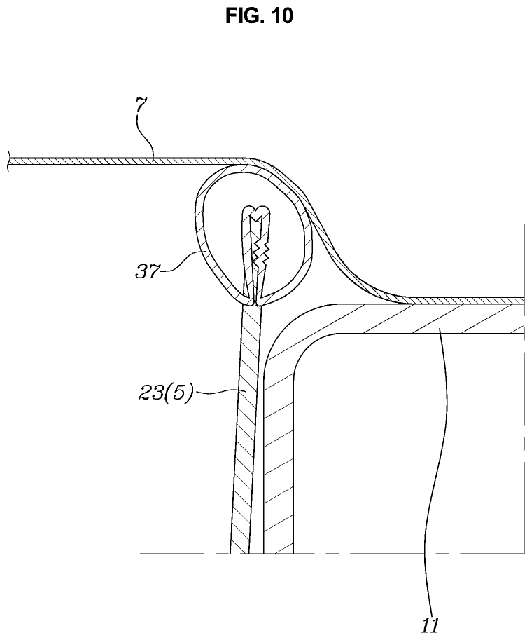

For reference, FIG. 7 and FIG. 8 illustrate an example in which the flange portions 25 are provided on both the upper and lower end portions of the inclined wall 23, and FIG. 9 and FIG. 10 illustrate an example in which the flange portion 25 is provided only on the lower end portion of the inclined wall 23.

At least one of the center side members 11, the front cross member 13, and the rear cross member 15 may include an internal wall 27 provided in a form of a vertical wall surface directed toward the watertight panel 5. Mounting protruding portions 29 may be provided on the internal wall 27, which is provided in a form of the vertical wall surface, and locally protrude to be in surface-contact with the inclined wall 23 of the watertight panel 5.

The watertight panel 5 needs to be coupled to the center side members 11, the front cross member 13, and the rear cross member 15. To the present end, the mounting protruding portion 29 is provided, and surface-contact portions between the mounting protruding portion 29 and the watertight panel 5 are coupled by welding or the like.

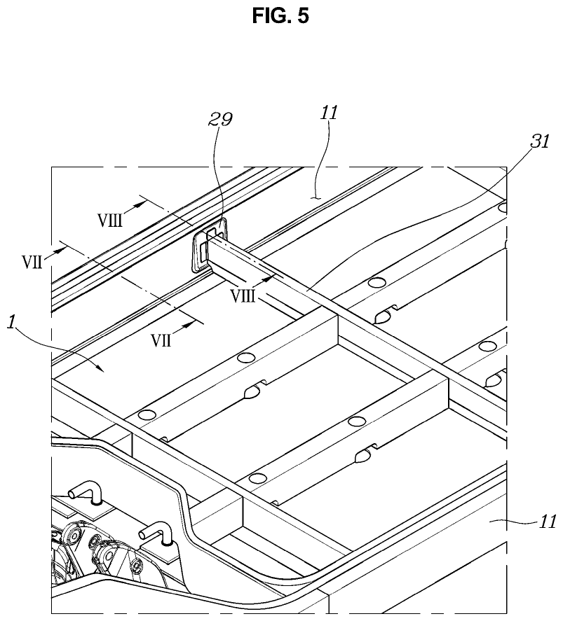

As illustrated in FIGS. 5 to 8, in an exemplary embodiment of the present disclosure, the mounting protruding portion 29 is locally provided on the internal wall 27 of the center side member 11, and the inclined wall 23 of the watertight panel 5, which is in surface-contact with the mounting protruding portion 29, is coupled to the mounting protruding portion 29 by welding or the like.

A plurality of internal members 31 may be provided in the watertight panel 5 and traverse the inside of the battery accommodation space 1, and the mounting protruding portions 29 may be formed to face end portions of the internal members 31.

FIG. 5 illustrates a state in which the watertight panel 5 is excluded, and the end portion of the internal member 31 is aligned to face the mounting protruding portion 29 of the center side member 11.

When the internal members 31 provided in the watertight panel 5 are disposed to face each other with the watertight panel 5 interposed therebetween as described above, the mounting protruding portions 29 and the internal members 31 define secure load paths against an impact force or the like inputted through the center side members 11 from lateral sides of the vehicle, suppressing deformation of the battery accommodation space and more safely protecting the battery modules.

Of course, the internal members 31 may be coupled to the inside of the watertight panel 5 by separate welding or the like.

Meanwhile, the internal wall 27 of the center side member 11 may be formed to have the same inclination as the inclined wall 23 of the watertight panel 5. In the instant case, an adverse effect, such as the occurrence of undercuts or the deterioration in workability, may occur during a press process of forming an internal member 33 including the internal wall 27 of the center side member 11.

That is, a press mold for forming the internal member 33, in which the internal wall 27 of the center side member 11 is formed to be parallel to the inclined wall 23 of the watertight panel 5, causes the undercut on a lower wing portion 35 of the two wing portions 35 connected to upper and lower portions of the internal wall 27 in case that a portion of the internal wall 27 has a horizontal cavity. For the present reason, a defect rate may increase during the pressing process because of a difference in length between the two wing portions 35 in case that the portion of the internal wall 27 has an inclined cavity.

That is, in an exemplary embodiment of the present disclosure described above, the internal wall 27 of the center side member 11 is provided in a form of a vertical wall, and the mounting protruding portions 29 locally protrude. Therefore, it is possible to ensure excellent coupling characteristics with the watertight panel 5 while suppressing the above-mentioned adverse effect occurring during the pressing process.

Furthermore, with the above-mentioned configuration, welding gas, which is produced during the process of welding the watertight panel 5 and the mounting protruding portion 29, may be easily discharged through a gap between the watertight panel 5 and the mounting protruding portion 29, and a coating liquid may easily penetrate into a space between the center side member 11 and the watertight panel 5 so that the coating is more easily and assuredly performed, improving rustproof performance of the chassis frame 3 and the watertight panel 5.

Furthermore, in case that the internal wall 27 of the center side member 11 is formed to be inclined at the same angle as the inclined wall 23 of the watertight panel 5, the management for maintaining a flat surface needs to be performed on a substantially wide surface. For the present reason, the manufacturability may deteriorate in comparison with a case in which the mounting protruding portion 29 is provided locally to be in surface-contact with the watertight panel 5. As described above, in an exemplary embodiment of the present disclosure, the mounting protruding portion 29 may be locally formed only on the center side member 11, improving the manufacturability of the vehicle.

Meanwhile, an upper sealing strip 37 may be provided at the upper end portion of the watertight panel 5 and compressed against the upper cover 7 to improve watertightness.

Furthermore, an under sealing strip 39 may be provided at a lower end portion of the watertight panel 5 and compressed against the under cover 9 to improve watertightness.

FIG. 9 and FIG. 10 illustrate an example in which the upper sealing strip 37 and the under sealing strip 39 are provided.

The upper sealing strip 37 and the under sealing strip 39 may each be formed in an annular shape as a whole and have a cross-sectional shape which may be press-fitted into the upper or lower end portion of the watertight panel 5. The upper sealing strip 37 and the under sealing strip 39 may each have a surface made of a material, such as rubber, which may ensure watertightness.

The present disclosure may also be expressed as follows.

That is, the exemplary embodiment of the electric vehicle structure of the present disclosure includes the side members 17 configured to define the two opposite sides of the chassis frame 3, the plurality of cross members configured to connect the side members 17 at the two opposite sides, the watertight panel 5 inserted into the closed curve defined by the side members 17 and the cross members, the watertight panel 5 being configured to define a closed curved surface including a predetermined width in an upward and downward direction and including watertightness, and the upper cover 7 provided to surround the upper side of the battery accommodation space 1 surrounded by the closed curved surface defined by the watertight panel 5.

The closed curve of the chassis frame 3 may be defined by the center side members 11, which are positioned between the front side members 19 and the rear side members 21 of the side members 17, the front cross member 13, which connects the two opposite end portions of the front sides of the center side members 11, and the rear cross member 15 that connects the two opposite end portions of the rear sides of the center side members 11.

The closed curved surface of the watertight panel 5, which has a predetermined width in the upward/downward direction, may be defined by the inclined wall 23 inclined downwardly from the upper side of the battery accommodation space 1 toward the inside of the battery accommodation space 1.

The flange portion 25 may be provided at the upper end portion of the inclined wall 23 of the watertight panel 5 and smoothly extend in the horizontal direction thereof.

The upper sealing strip 37 may be provided at the upper end portion of the inclined wall 23 of the watertight panel 5 and compressed against the upper cover 7 to improve watertightness.

The upper sealing strip 37 may be provided to be compressed against the inside of a bent portion 41 of the upper cover 7.

The upper sealing strip 37 illustrated in FIG. 9 and FIG. 10 may be compressed against the inside of the bent portion 41 of the upper cover 7, further improving the watertightness.

As illustrated in FIG. 9, the under cover 9 may be provided at the lower side of the watertight panel 5 and surround the lower side of the battery accommodation space 1, and the under sealing strip 39 may be provided at the flange portion 25 at the lower end portion of the inclined wall 23 of the watertight panel 5 and compressed against the under cover 9 to improve watertightness.

As illustrated in FIG. 7 or 8, a cooling panel 43 may be provided at a lower side of the inclined wall 23 of the watertight panel 5 and surround the lower side of the battery accommodation space 1, and the under cover 9 may be provided at the lower side of the cooling panel 43 and surround the lower side of the cooling panel 43.

A flow path is formed in the cooling panel 43, and a refrigerant flows through the flow path so that the battery module accommodated in the battery accommodation space 1 may be effectively cooled.

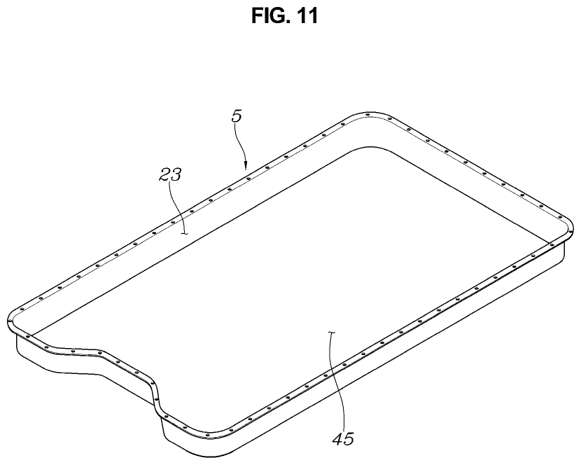

Meanwhile, as illustrated in FIG. 11, a bottom portion 45 may be integrated with the watertight panel 5 and extend from the lower end portion of the inclined wall 23 to seal the lower side of the battery accommodation space 1.

At least one of the center side members 11, the front cross member 13, and the rear cross member 15, which face the inclined wall 23 of the watertight panel 5, may include the mounting protruding portion 29 protruding to be locally in surface-contact with the inclined wall 23.

The plurality of internal members 31 may be provided in the watertight panel 5 and include the end portions supported on the inclined wall 23 of the watertight panel 5, and the mounting protruding portions 29 may be formed at the positions facing the end portions of the internal member 31.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle structure comprising:
a chassis frame having a first closed curve that surrounds a battery accommodation space;
a watertight panel having a second closed curve that surrounds an inside of the first closed curve that surrounds the battery accommodation space of the chassis frame;
an upper cover coupled to an upper side of the watertight panel and covering an upper side of the battery accommodation space; and
an under cover coupled to a lower side of the watertight panel and covering a lower side of the battery accommodation space.

2. The vehicle structure of claim 1, wherein the first closed curve, which surrounds the battery accommodation space of the chassis frame, is defined by center side members provided at first and second opposite sides of the chassis frame of a vehicle and elongated in a forward and rearward direction of the vehicle, front and rear cross members connecting the center side members at the first and second opposite sides, elongated in a transverse direction of the vehicle, and spaced from each other in the forward and rearward direction of the vehicle.

3. The vehicle structure of claim 2, wherein the watertight panel includes an inclined wall, which extends along internal surfaces of the center side members, an internal surface of the front cross member, and an internal surface of the rear cross member, defines the second closed curve and is seamless.

4. The vehicle structure of claim 3, wherein the inclined wall of the watertight panel is inclined downwardly from the upper side of the battery accommodation space toward an inside of the battery accommodation space.

5. The vehicle structure of claim 4, wherein a flange portion is provided on at least one of upper and lower end portions of the inclined wall of the watertight panel and seamlessly extends in a horizontal direction of the vehicle.

6. The vehicle structure of claim 4, wherein at least one of the center side members, the front cross member, and the rear cross member includes an internal wall provided in a form of a vertical wall surface directed toward the watertight panel, and a mounting protruding portion is provided on the internal wall, which is provided in a form of the vertical wall surface, and locally protrudes to be in surface-contact with the inclined wall of the watertight panel.

7. The vehicle structure of claim 6, wherein a plurality of internal members is provided in the watertight panel and traverses the inside of the battery accommodation space, and the mounting protruding portion is formed to face an end portion of the internal member.

8. The vehicle structure of claim 4, wherein an upper sealing strip is mounted at an upper end portion of the watertight panel and compressed against the upper cover to improve watertightness.

9. The vehicle structure of claim 4, wherein an under sealing strip is mounted at a lower end portion of the watertight panel and compressed against the under cover to improve watertightness.

10. A vehicle structure including:
side members defining first and second opposite sides of a chassis frame;
a plurality of cross members connecting the side members at the first and second opposite sides;
a watertight panel inserted into a closed curve defined by the side members and the cross members, the watertight panel being configured to define a closed curved surface having a predetermined width in an upward and downward direction and having watertightness; and
an upper cover provided to surround an upper side of a battery accommodation space surrounded by the closed curved surface defined by the watertight panel.

11. The vehicle structure of claim 10, wherein a closed curve of the chassis frame is defined by center side members, which are positioned between front side members and rear side members of the side members, a front cross member, which connects first and second opposite end portions of front sides of the center side members, and a rear cross member that connects first and second opposite end portions of rear sides of the center side members.

12. The vehicle structure of claim 11, wherein the closed curved surface, which has the predetermined width in the upward and downward direction of the watertight panel, is defined by an inclined wall inclined downwardly from the upper side of the battery accommodation space toward an inside of the battery accommodation space.

13. The vehicle structure of claim 12, wherein a flange portion is provided at an upper end portion of the inclined wall of the watertight panel and extends in a horizontal direction of a vehicle.

14. The vehicle structure of claim 12, wherein an upper sealing strip is mounted at an upper end portion of the inclined wall of the watertight panel and compressed against the upper cover to improve watertightness.

15. The vehicle structure of claim 14, wherein the upper sealing strip is mounted to be compressed against an inside of a bent portion of the upper cover.

16. The vehicle structure of claim 12,
wherein an under cover is provided at a lower side of the watertight panel and surrounds a lower side of the battery accommodation space, and
wherein an under sealing strip is mounted at a lower end portion of the inclined wall of the watertight panel and compressed against the under cover to improve watertightness.

17. The vehicle structure of claim 12,
wherein a cooling panel is mounted at a lower side of the inclined wall of the watertight panel and surrounds a lower side of the battery accommodation space, and
wherein an under cover is provided at a lower side of the cooling panel and surrounds the lower side of the cooling panel.

18. The vehicle structure of claim 12, wherein a bottom portion is integrated with the watertight panel and extends from a lower end portion of the inclined wall to seal a lower side of the battery accommodation space.

19. The vehicle structure of claim 12, wherein at least one of the center side members, the front cross member, and the rear cross member, which face the inclined wall of the watertight panel, includes a mounting protruding portion protruding to be locally in surface-contact with the inclined wall.

20. The vehicle structure of claim 19, wherein a plurality of internal members is provided in the watertight panel and has end portions supported on the inclined wall of the watertight panel, and the mounting protruding portion is formed at a position facing the end portions of the internal members.
